(19) United States
(12) Patent Application Publication
(10) Pub. No.: US 2008/0319813 A1
(43) Pub. Date: Dec. 25, 2008

(54) METHODS AND APPARATUS FOR COLLABORATIVE PROCESS MODELING

(75) Inventors: Jacobus du Preez, Snoqualmie, WA (US); Wynand du Toit, Little Falls (ZA); Ben Fourie, Radiokop (ZA)

Correspondence Address: BELL, BOYD & LLOYD, LLP, P.O. Box 1135, CHICAGO, IL, 60690, US

(73) Assignee: SourceCode Technology Holding, Inc., Redmond, WA (US)

(21) Appl. No.: 12/126,416

(22) Filed: May 23, 2008

Related U.S. Application Data
(60) Provisional application No. 60/939,981, filed on May 24, 2007.

(51) Int. Cl. G06Q 10/00

(52) U.S. Cl. 705/7

(57) ABSTRACT

The present disclosure provides methods and apparatuses for collaborative process modeling. Using the methods and apparatus herein, users can utilize a plurality of modeling canvases with a plurality of functionality levels during business process design. Additionally, a plurality of users can work collaboratively on a single business process design.

### CROSS-REFERENCE TO RELATED APPLICATIONS

The present application claim benefit to U.S. Patent Application No. 60/939,981, METHODS AND APPARATUS FOR COLLABORATIVE PROCESS MODELING, filed May 24, 2007 the entire contents of which are incorporated herein by reference.

### BACKGROUND

A business process is a combination of operational steps or activities that a business undertakes. A business may conduct a high number of business processes throughout the course of a day or year, in order to accomplish the business's goals. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Business can now also incorporate business process design into their existing technology systems. Instead of providing a simple map of a business process, integration with computer systems allows business process designers to design interactive business processes that drive business workflow. Business process designers can receive data from various sources, perform a wide range of actions on the data directly, and create business processes in an easy to understand visual manner.

Businesses create workflows as a part of business process design to assist in managing their internal operations. Business processes allow users to represent the current state of their business operations in a graphical manner. Users can also simulate new business operations through the use of business processes.

Business process designers can come from a number of different business roles. For example, business users, developers, administrators, customer service representatives, etc. may participate in business process design. The various designers need the ability to utilize the modeling canvas with which they are most comfortable while working on a single business process design. For example, the designers may wish to work in an iterative process where the process is passed between designers based on the designers' areas of expertise and each business process designer uses a different modeling tool.

### SUMMARY

The present disclosure provides methods and apparatuses for collaborative process modeling. Using the methods and apparatus herein, users can utilize a plurality of modeling canvases with a plurality of functionality levels during business process design. Additionally, a plurality of users can work collaboratively on a single business process design.

Additional features and advantages are described herein, and will be apparent from, the following Detailed Description and the figures.

### BRIEF DESCRIPTION OF THE FIGURES

FIG. 1 is a high level block diagram of an example business process design system.

FIG. 2 is a more detailed block diagram showing one example of a client device.

FIG. 3 is a more detailed block diagram showing one example of a server.

FIG. 4 is an example system hierarchy.

FIG. 5 is a flowchart of an example process for creating and editing a business process workflow in a collaborative environment.

FIG. 6 is an example of a business process workflow design screen.

FIG. 7 is an example of business process workflow binding screen.

FIG. 8 is an example of a binding wizard screen.

FIG. 9 is an example of a binding connections screen.

FIG. 10 is an example of a business process workflow design screen in a second design environment.

FIG. 11 is an example of a view item screen.

FIG. 12 is an example of a workflow model view screen.

### DETAILED DESCRIPTION

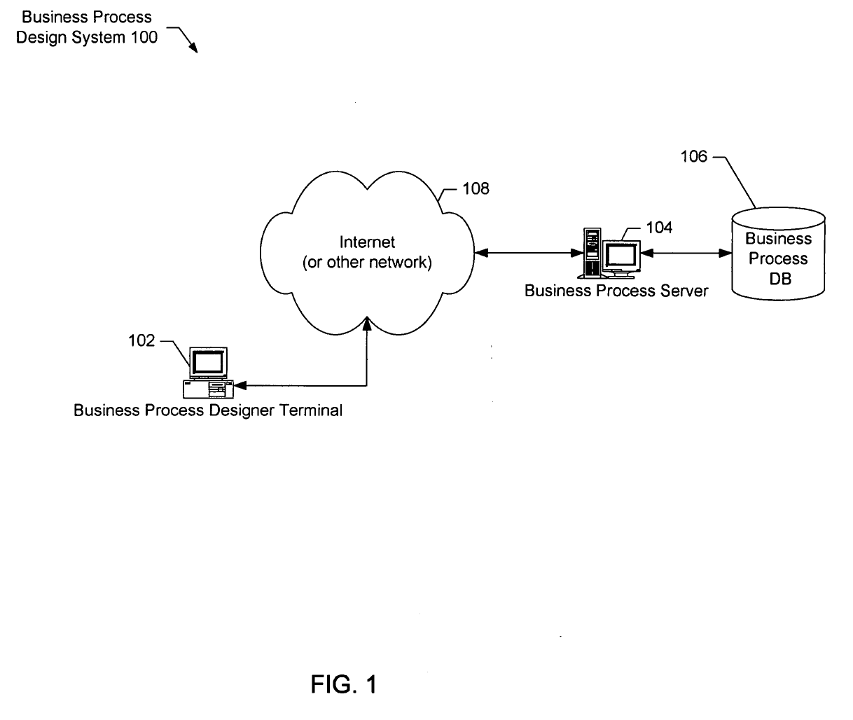

The present system is most readily realized in a network communications system. A high level block diagram of an exemplary business process design system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

One business process server 104 may interact with a large number of business process designer terminals 102. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

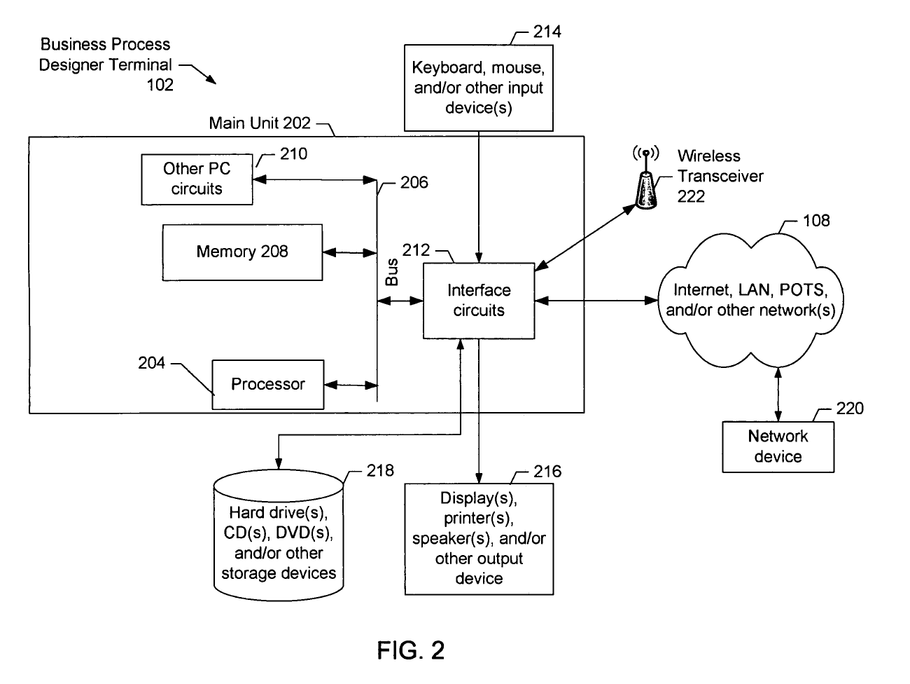

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

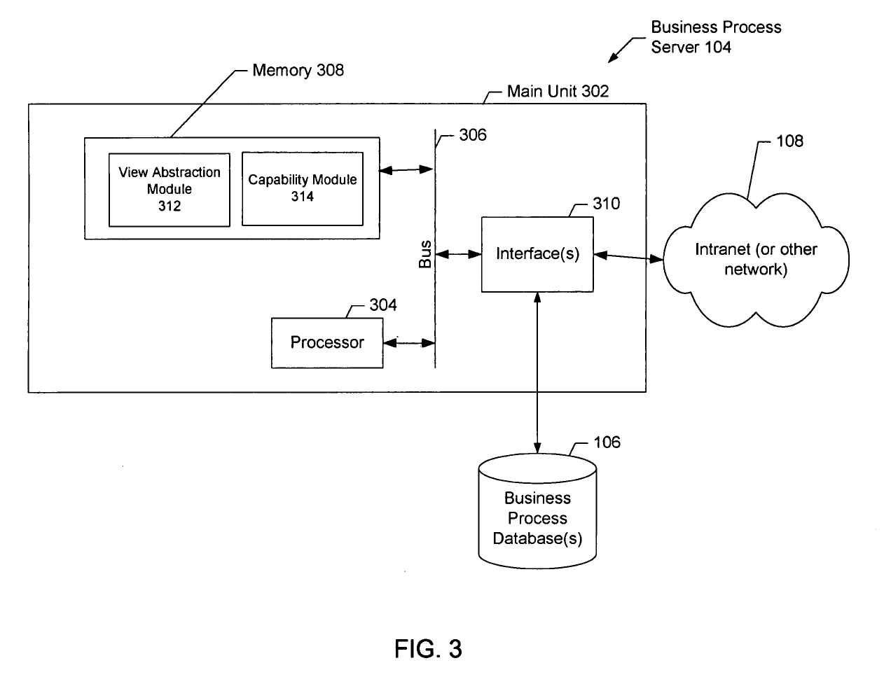

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory.

In particular, the memory 308 preferably stores a View Abstraction Module 312 and a Capability Module 314. The View Abstraction Module 312 may abstract a business process workflow so that any visual design environment may be used to view and/or edit the business process workflow. For example, the View Abstraction Module 312 allows a business process designer to use Visio, Visual Studio, etc.

The Capability Module 314 may control the functionality offered to a designer and/or category of designer. For example, the Capability Module 314 may restrict the options available to a business process designer in a “business analyst” group. The options for the “business analyst” group may be limited to using pre-set templates. However, the Capability Module 314 may allow a business process designer in a “technical specialist” group to access the underlying data systems. The Capability Module 314 may control the access of the different business process designer groups through deployment of application programming interfaces to the business process designer terminals 102. In another example, the Capability Module 314 may store, in the business process database 106, capability information of the business process designer groups based on application programming interfaces located on the business process designer terminals 102.

The View Abstraction Module 312 may allow a business process designer to store a process design and allow interpretation of the process design in any visual design environment the business process designer wishes to use. For example, if a business process designer creates a business process workflow in Visio, the business process designer can store the business process workflow into a business object that can be read by Visual Studio. The business object may be a declarative object. For example, Visio may store the object as a declarative XML object representing the workflow, and the declarative XML object may be interpreted by Visual Studio. Application programming interfaces assist in interpreting the declarative object into a visual representation by the graphical editors. For example, application programming interfaces deployed by the Capability Module 314 may interpret the declarative object for view by Visio, Visual Studio, etc.

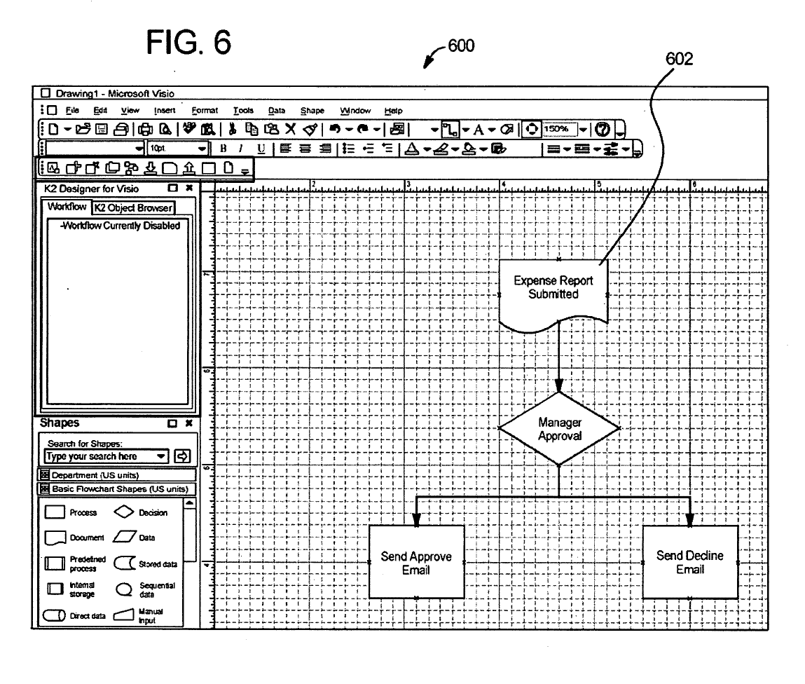

The View Abstraction Module 312 may also allow a business process designer to bind business process workflow objects to shapes in a graphical design environment. For example, if a business process designer creates a graphical diagram of a business process, the View Abstraction Module 312 allows the business process designer to bind the shapes and/or lines of the graphical diagram to actual business process workflow objects, as shown in greater detail in relation to FIGS. 6-9.

The View Abstraction Module 312, allows the business process server 104 to display a business process module in any graphical environment, including a web based client. For example, the business process designer terminal 102 can request to view a business process workflow that was created in a Visio environment. The business process server 104 may transmit a graphical representation to the web browser on the business process designer terminal 102 using the View Abstraction Module 312 to interpret the declarative object into a graphical representation via application programming interfaces.

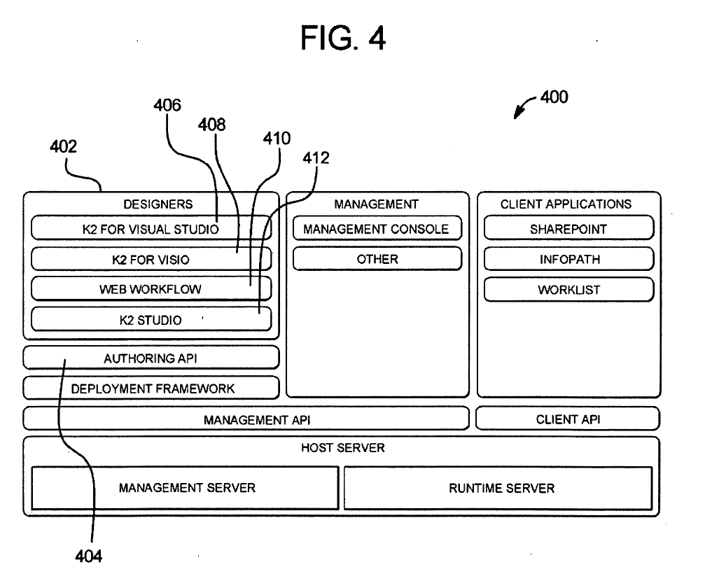

An example system hierarchy 400 is presented in FIG. 4. Although the example system hierarchy 400 is described in reference FIG. 4, it will be appreciated that many other configurations are possible. For example, elements could be in different locations, elements could have different names, and/or elements could have different graphical representations.

In an example system, the authoring application programming interfaces 402 are at a layer underneath the designer layer 404. The designers have a number of different design environments available. For example, Visual Studio 406, Visio 408, a web designer 410, a proprietary Studio 412, etc. The authoring Application programming interfaces may include Design application programming interfaces and Authoring application programming interfaces. The Application programming interfaces provide a consistent platform for creating, storing and interpreting a declarative object. The business process designer can use any design environment and consistent editing, storing and interpretation is guaranteed. This allows business designers with different roles or capabilities to use the design environment best suited to their roles.

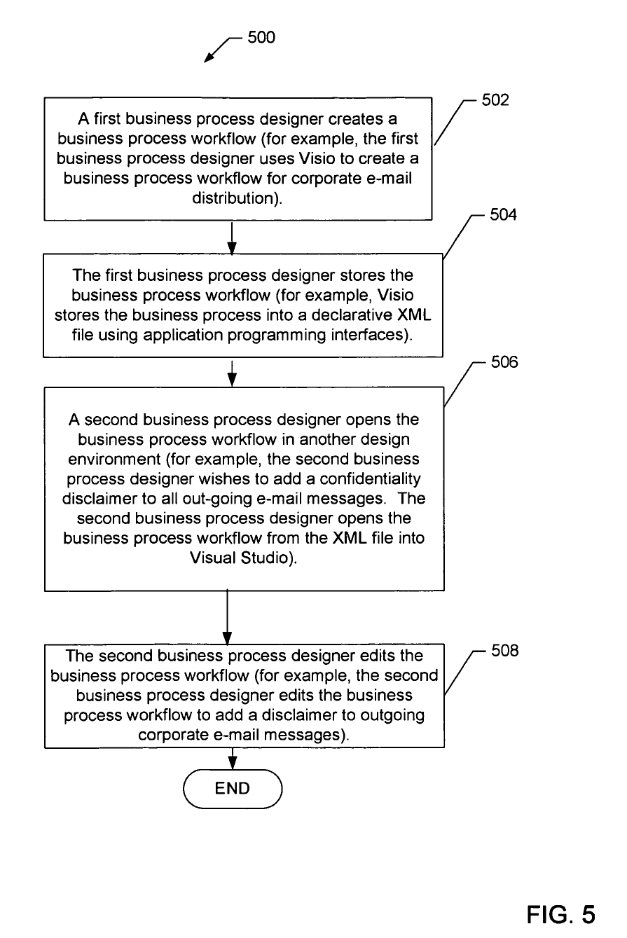

A screenshot flowchart of an example process for creating and editing a business process workflow in a collaborative environment 500 is presented in FIG. 5. Although the flowchart of an example process 500 is described in reference FIG. 5, it will be appreciated that many other configurations are possible. For example, elements could be in different locations, elements could have different names, and/or elements could have different graphical representations.

In block 502, a first business process designer creates a business process workflow. For example, the Capability Module 314 may enable a Visio environment to create a fully functional business process workflow. The first business process designer uses the Visio studio on a first business process designer terminal 102 to create a business process workflow for corporate e-mail. In another example, the Capability Module 314 does not enable the Visio environment to create a fully functional business module. In this example, the first business process designer creates a graphical representation of a workflow without the functionality of the business process workflow. In other words, the business process designer uses the pre-existing Visio shapes to model a workflow process. The business process designer then binds a business process to the non-functional workflow process, as shown in further detail in FIGS. 6-9, to create a functional business process workflow.

In block 504 the first business process designer stores the business process workflow. For example, using application programming interfaces provided by the Capability Module 314, the first business process designer stores the business process workflow into a declarative XML file. It should be understood that various other embodiments of the stored object are possible.

In block 506, a second business process designer opens the business process workflow in another design environment. For example, using a second business process designer terminal 102, the second business process designer opens the declarative XML file into Visual Studio. Visual Studio may use application programming interfaces provided by the Capability Module 314 to interpret the declarative XML file into a functional and graphical representation of the business process workflow.

In block 508, the second business process designer edits the business process workflow. For example, the Capability Module 314 may provide certain application programming interfaces to allow editing functions to be performed on the business process designer terminal 102 based on the business process designer's role in the workflow design process. In another example, Visual Studio may natively have functions available for editing the workflow process such as editing the workflow model. The business process editor may use the functionality of Visual Studio to add a confidentiality disclaimer to all outgoing e-mail messages.

In this way, a business process workflow may be created and edited by a number of business process designers with different roles and using the environments with which they are the most comfortable.

A screenshot of an example business process workflow design screen 600 is presented in FIG. 6. Although the example business process workflow design screen 600 is described in reference FIG. 6, it will be appreciated that many other configurations are possible. For example, elements could be in different locations, elements could have different names, and elements could have different graphical representations.

The business process workflow design screen 600 may have a graphical design environment 602 for business process design. In one example, the graphical design environment 602 provides the business process designer the ability to create functional business process workflows. In another example, the graphical design environment 602 uses application programming interfaces to bind a non-functional business process workflow design to functional business process workflow elements.

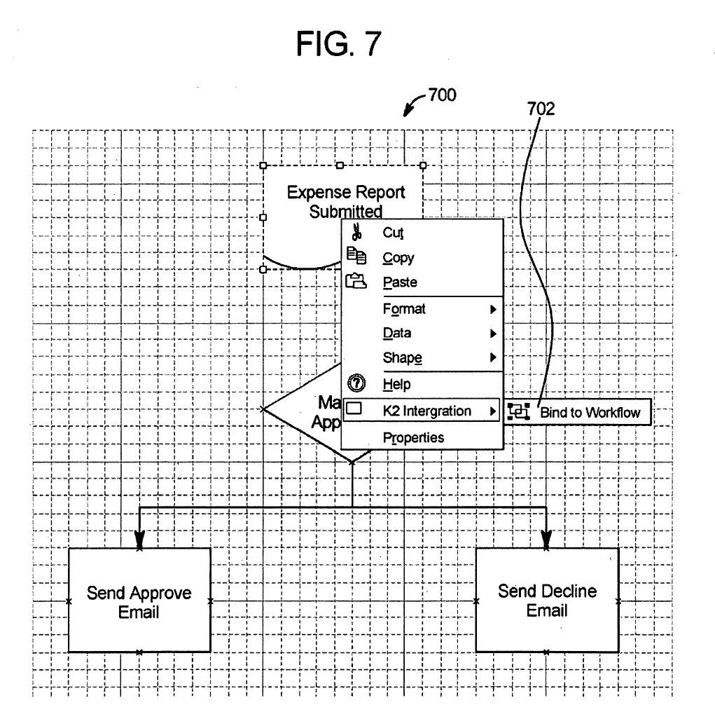

A screenshot of an example business process workflow binding screen 700 is presented in FIG. 7. Although the example business process workflow binding screen 700 is described in reference FIG. 7, it will be appreciated that many other configurations are possible. For example, elements could be in different locations, elements could have different names, and elements could have different graphical representations.

The business process workflow binding screen 700 may have a binding option 702. The binding option 702 allows the business process designer to bind a non-functional business process workflow design to functional business process workflow elements. Binding allows the business process designer to create a business process workflow using representations that the business process designer is familiar with, and then select the functionality that the business process designer wishes the graphical object to represent. For example, the business process designer may bind a rectangular shape to a decision workflow object.

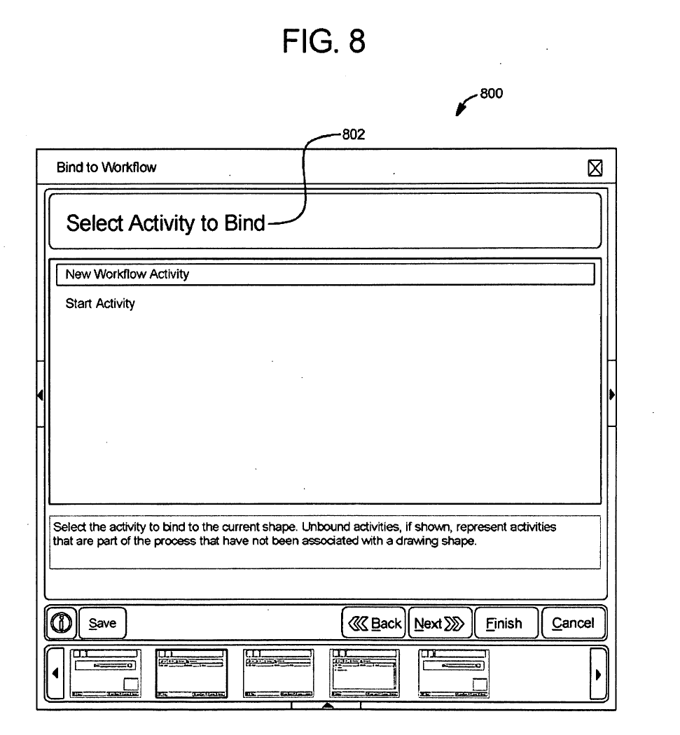

A screenshot of an example binding wizard screen 800 is presented in FIG. 8. Although the example binding wizard screen 800 is described in reference FIG. 8, it will be appreciated that many other configurations are possible. For example, elements could be in different locations, elements could have different names, and elements could have different graphical representations.

The binding wizard allows the business process designer to bind the various graphical elements to business process workflow objects. The binding wizard may have a binding option selection 802, which allows the business process designer to choose from pre-existing business process workflow objects or to create new objects.

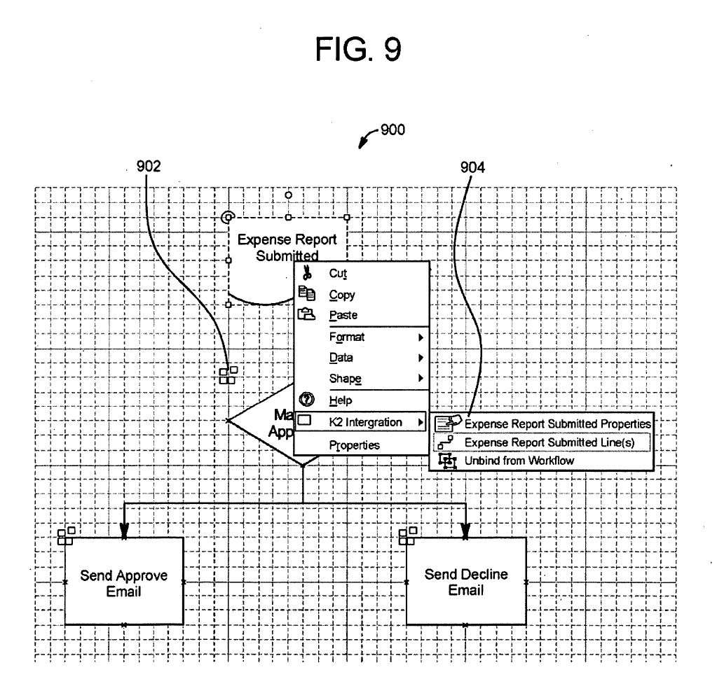

A screenshot of an example binding connections screen 900 is presented in FIG. 9. Although the example binding connections screen 900 is described in reference FIG. 9, it will be appreciated that many other configurations are possible. For example, elements could be in different locations, elements could have different names, and elements could have different graphical representations.

The binding connections screen 900 may have bound object representations 902. The bound object representations 902 indicate to the business process designer that the graphical object is bound to a business process workflow object. The binding connections screen 900 may also have a bind connections option 904. The bind connections option 904 allows the business process designer to bind connecting lines to business process workflow objects. For example, a business process designer can bind a line to a business process workflow object requiring that an “Expense Report” object has a “Submitted” status before continuing to the next business process workflow activity.

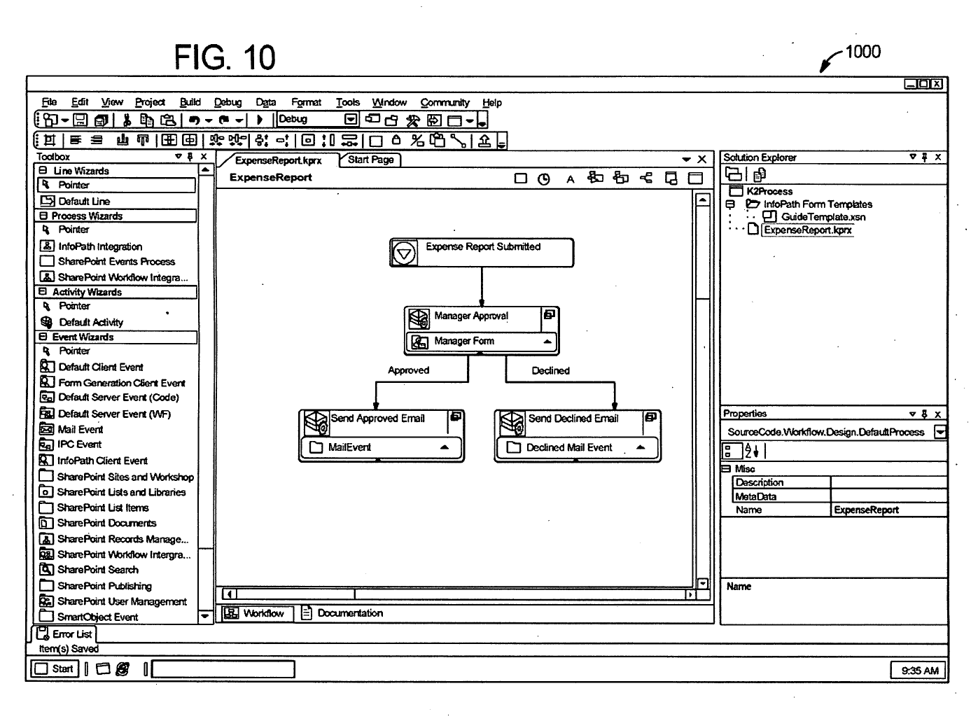

A screenshot of an business process workflow design screen in a second design environment 1000 is presented in FIG. 10. Although the example screenshot 1000 is described in reference FIG. 10, it will be appreciated that many other configurations are possible. For example, elements could be in different locations, elements could have different names, and elements could have different graphical representations.

The business process workflow design screen in a second design environment 1000 is an example of a workflow, which was created and saved in a first design environment as a declarative object, opened in a second design environment. For example, the workflow may have been created in Visio (as shown in FIG. 6) and is now opened in a the Visual Studio environment. Application programming interfaces allow for platform for creating, storing and interpreting the declarative object between design environments.

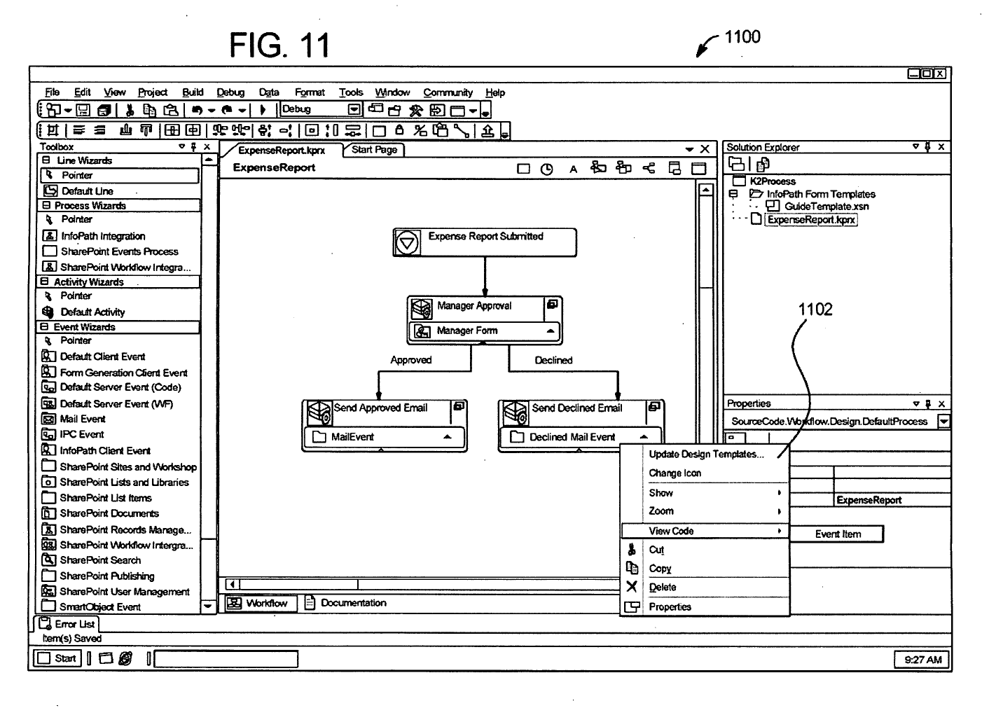

A screenshot of an example view item screen 1100 is presented in FIG. 11. Although the example view item screen 1100 is described in reference FIG. 11, it will be appreciated that many other configurations are possible. For example, elements could be in different locations, elements could have different names, and elements could have different graphical representations.

The view item screen 1100 may allow the business process designer to view a portion of a workflow in greater detail. For example, the business process designer may wish to use the capabilities of Visual Studio to view the workflow model in greater detail. The business process can be further extended in the Visual Studio environment. The business process designer can access the declarative models of the underlying business process, via a menu 1102, and extend it beyond what the Visio designer allowed by using developer tools.

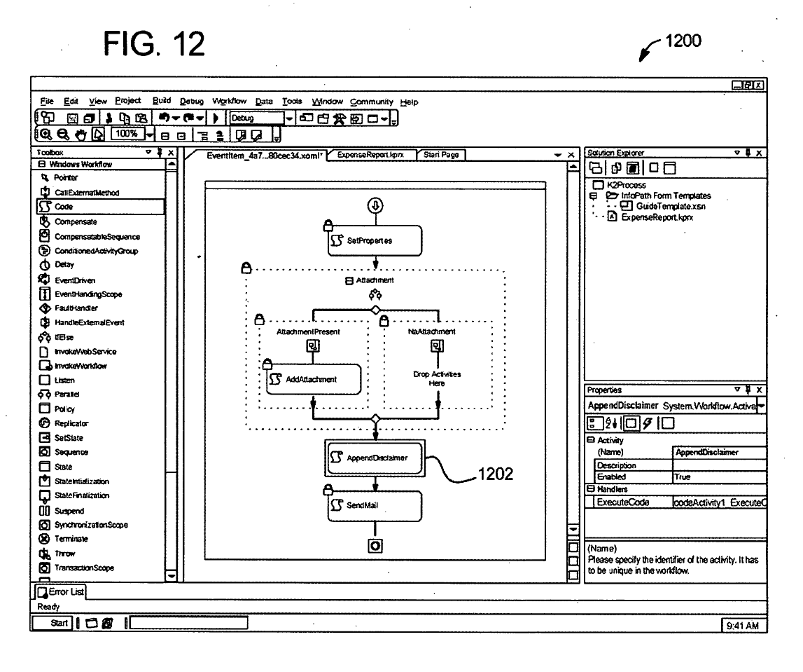

A screenshot of an example workflow model view screen 1200 is presented in FIG. 12. Although the example workflow model view screen 1200 is described in reference FIG. 12, it will be appreciated that many other configurations are possible. For example, elements could be in different locations, elements could have different names, and elements could have different graphical representations.

The workflow model view screen 1200 may allow the business process designer to view and edit the workflow model associated with a business process workflow. For example, a business process designer can add workflow modules to the workflow model to add a disclaimer to outgoing corporate e-mail messages. The Visual Studio environment allows a business process designer to access the workflow model, whereas a Visio environment may not allow the same functionality. For example, the business process designer adds the “Append Disclaimer Text” module 1202 to the creation of the email message to ensure that every email sent by this process contains the approved corporate disclaimer. In this way, business process designers with different roles and capabilities can use the proper design environments while editing the same business process workflow. Application programming interfaces on the business process designer terminals 102 or business process servers 104 allow the various design environments to maintain consistent platform for creating, storing and interpreting the business process workflows by using declarative objects, such as declarative XML.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for collaborative process modeling, the process comprising:
providing a first design environment;
creating a first business process workflow;
storing the first business process workflow created in the first design environment into a first declarative object via application programming interfaces;
providing a second design environment;
restoring via application programming interfaces the first declarative object for use in the second design environment into a second business process workflow;
editing the second business process workflow;
storing the second business process workflow into a second declarative object via application programming interfaces; and
storing the second declarative object.

2. The method of claim 1, wherein the first design environment has a first capability level and the second design environment has a second capability level.

3. The method of claim 1, wherein the first declarative object and the second declarative object are in an XML format.

4. The method of claim 1, wherein the application programming interfaces provide a consistent platform for creating, storing and interpreting the declarative object.

5. The method of claim 1, wherein creating the first business process workflow includes binding a graphical object to a declarative business process workflow object.

6. The method of claim 5, including providing application programming interfaces to bind the graphical object to the business process workflow object.

7. A system for collaborative process modeling, the system comprising:
a processor for:
providing a first design environment;
creating a first business process workflow;
storing the first business process workflow created in the first design environment into a first declarative object via application programming interfaces;
providing a second design environment;
opening the first declarative object via application programming interfaces for use in the second design environment into a second business process workflow;
editing the second business process workflow; and
storing the second business process workflow into a second declarative object via application programming interfaces; and
a storage for:
storing the second declarative object.

8. The system of claim 7, wherein the first design environment has a first capability level and the second design environment has a second capability level.

9. The system of claim 7, wherein the first declarative object and the second declarative object are in an XML format.

10. The system of claim 7, wherein creating the first business process workflow includes binding a graphical object to a declarative business process workflow object.

11. The system of claim 10, including providing application programming interfaces to bind the graphical object to the business process workflow object.

12. The system of claim 7, wherein the application programming interfaces provide a consistent platform for creating, storing and interpreting the declarative object.

13. A computer readable medium storing instructions to cause a computing device to:
provide a first design environment;
create a first business process workflow;
store the first business process workflow created in the first design environment into a first declarative object via application programming interfaces;
provide a second design environment;
open the first declarative object via application programming interfaces for use in the second design environment into a second business process workflow;
edit the second business process workflow;
store the second business process workflow into a second declarative object via application programming interfaces; and
store the second declarative object.

14. The computer readable medium of claim 13, wherein the first design environment has a first capability level and the second design environment has a second capability level.

15. The computer readable medium of claim 13, wherein the first declarative object and the second declarative object are in an XML format.

16. The computer readable medium of claim 13, wherein creating the first business process workflow includes binding a graphical object to a declarative business process workflow object.

17. The computer readable medium of claim 16, including providing application programming interfaces to bind the graphical object to the business process workflow object.

18. The computer readable medium of claim 13, wherein the application programming interfaces provide a consistent platform for creating, storing and interpreting the declarative object.
